(19) United States
(12) Patent Application Publication
(10) Pub. No.: US 2002/0167703 A1
(43) Pub. Date: Nov. 14, 2002

(54) Tandem filters for reducing intersymbol interference in optical communications systems

(76) Inventor: Scott Andrew Merritt, Pinner (GB)

Correspondence Address: RAUSCHENBACH PATENT LAW GROUP, POST OFFICE BOX 387, BEDFORD, MA, 01730, US

(21) Appl. No.: 09/848,096

(22) Filed: May 3, 2001

(51) Int. Cl. H04B 10/00; H04B 10/12

(52) U.S. Cl. 359/173; 359/161

(57) ABSTRACT

An optical fiber communication system is described that includes a data source that generates electrical data. A transmission filter filters the electrical data generated by the data source and passes a transmission spectrum. The transmitter filter has a transfer function that reduces adjacent symbol interference in a transmission spectrum. The bandwidth of the transmitter filter may be substantially optimized bandwidth. A modulator modulates the transmission spectrum on an optical signal. The modulator may be a substantially chirp-free modulator. A detector detects the modulated optical signal transmitted across an optical channel and converts the detected modulated optical signal to a received electrical data signal. A receiver filter filters the received electrical data signal. The receiver filter has a transfer function that reduces adjacent symbol interference in the received electrical data signal.

### FIELD OF THE INVENTION

The present invention relates to apparatus and methods for transmitting and receiving optical data that reduce intersymbol interference. In particular, the present invention relates to apparatus and methods for filtering and equalization of transmitted and received data to reduce the intersymbol interference caused by dispersion, nonlinearities in the optical channel, and photodetection.

### BACKGROUND OF THE INVENTION

Optical fiber communication systems are now widely deployed. Recently new communications services such as the Internet, high-speed data links, video services, and wireless services have resulted in a dramatic increase in the need for bandwidth. Data traffic is currently increasing at a rate of 80% per year and voice traffic is currently increasing at a rate of 10% per year.

One way of increasing bandwidth in optical fiber communications system is to increase the number of wavelengths of light or channels propagating in the optical fiber. Wavelength division multiplexing (WDM) is an optical technology that propagates many wavelengths in the same optical fiber, thus effectively increasing the aggregate bandwidth per fiber to the sum of the bit rates of each wavelength. Bandwidths greater than 10 terabits/sec have been demonstrated in WDM based communication systems with 40 Gb/s channels.

Many WDM and DWDM optical fiber communication system require transmission over long distances. The data rate and transmission distance of these systems are currently limited by intersymbol interference (ISI), which results from transmission impairments, such as chromatic dispersion, PMD, nonlinear propagation and the explicitly nonlinear process of photodetection.

Prior art linear equalization and filtering cannot eliminate these non-linear effects and combinations of these effects. Prior art transmission and reception filters, such as those meeting SONET specifications, are not capable of reducing the degradation caused by ISI, when the optical channel exhibits chromatic and polarization mode dispersion. For example, SONET standard receiver filters use 4^{th} order Bessel-Thompson filters with a −3 dB frequency of 0.75 times the bit rate. These filters do not improve the BER and Q statistic sufficiently. This is, in part, because of their poor equalization after aliasing at the bit rate. The Q statistic is the argument of the complementary error function and, therefore, is a measure of the bit error ratio.

Some prior art high-speed optical communication systems extend transmission distance by using chirped external modulation. Chirp is a linear increase or decrease in the optical signal's frequency as a function of time. Chirp is often quantified by the following chirp parameter.

$$α = 4 πΔ {f [ \frac{ⅆ ln ( ρ )}{ⅆ t} ]}^{- 1} ,$$

where ρ is optical power and Δf is an instantaneous change in optical frequency.

Chirp can compensate for the effects of dispersion and extend the transmission distance or dispersion tolerance of a communication system under certain conditions. Typical chirp values of −0.5 to −0.9 are used for 10 Gb/s channels with nearly 1,600 ps/nm dispersion.

Other prior art methods of increasing transmission distance use non-linear propagation effects to extend transmission distances. Soliton transmission techniques balance the tendency of optical pulses to disperse against nonlinear changes in the refractive index of optical fiber in order to compensate for the dispersion in the optical fiber.

These prior art methods (except for Solitons) are fixed dispersion compensation schemes. These methods leave a given amount of residual dispersion for channels at the edges of the WDM and DWDM spectrum.

### SUMMARY OF THE INVENTION

The present invention relates to apparatus and methods for improving the transmission and reception of optical signals distorted by dispersion and other non-nonlinearities in the optical channel. It is an object of the tandem filtering of the present invention to reduce intersymbol interference and extend transmission distances and dispersion tolerance for both chirped and non-chirped modulated communication systems. A discovery of the present invention is that electrical transmission and reception filters can be used to reduce ISI of optical signals photodetected after propagating over optical fibers with large dispersion.

A communication system of the present invention extends the use of zero-chirp or low-chirp modulators to some long-haul transmission systems. Using zero-chirp or low-chirp modulators is advantageous because they are more stable to temperature changes.

Accordingly, the present invention features an optical communication system that includes a data source that generates electrical data. A transmission filter filters the electrical data generated by the data source and passes a transmission spectrum. The transmission filter has a transfer function that reduces adjacent symbol interference in a transmission spectrum. In one embodiment, the transfer function of the transmitter filter has substantially optimized bandwidth. The transfer function of the transmitter filter may have substantially 100% excess bandwidth, which is defined as the maximum frequency of the spectrum normalized by half the bit rate minus 100%.

A modulator modulates the transmission spectrum on an optical signal. In one embodiment, the modulator comprises a substantially chirp-free modulator. A detector detects the modulated optical signal transmitted across an optical channel and converts the detected modulated optical signal to a received electrical data signal.

A receiver filter filters the received electrical data signal. The receiver filter has a transfer function that reduces adjacent symbol interference in the received electrical data signal. The transfer function of the receiver filter may reduce adjacent symbol interference in the received electrical data signal resulting from dispersion in the optical channel. The transfer function of the receiver filter may also reduce adjacent symbol interference in the received electrical data signal resulting from the non-linear effects of photodetection. In one embodiment, the transfer function of the receiver filter has a peak transmission that is a function of the dispersion across the optical channel. The phase response is different from that achieved with inductive peaking of a detector and transimpedance amplifier.

In one embodiment, the transfer function of the receiver filter substantially maximizes the lower bound on Q set by ISI. In one embodiment, the receiver filter transforms the detected electrical data signal to a signal that has an autocorrelation function that is substantially equal to a portion of the electrical data generated by the data source. The autocorrelation function may have an adjacent symbol interference that is less than 5%.

The present invention also features an optical communication system that has substantially optimized bandwidth. The system includes a data source that generates electrical data. A transmission filter having optimized bandwidth filters the electrical data generated by the data source and passes a transmission spectrum. The transmission filter has a transfer function that has substantially optimized bandwidth and that reduces adjacent symbol interference in a transmission spectrum. In one embodiment, the transfer function of the transmitter filter has substantially 100% excess bandwidth; this implies careful shaping of the transmitted optical spectrum.

A modulator modulates the transmission spectrum on an optical signal. In one embodiment, the modulator comprises a substantially chirp-free modulator. A detector detects the modulated optical signal transmitted across the dispersive optical channel and converts the detected modulated optical signal to a received electrical data signal.

The receiver's post-detection electrical equalization filter has an amplitude and phase response that reduces adjacent symbol interference in the received electrical data signal resulting from dispersion in the optical channel. In one embodiment, the transfer function of the receiver filter has a peak transmission that is a function of the dispersion across the optical channel. The transfer function of the receiver filter also has a phase response that substantially reduces adjacent symbol and maximizes the ISI-induced-limit for Q, i.e. it improves the OSNR-limited sensitivity floor.

The present invention also features a method of reducing intersymbol interference in an optical channel. The method includes generating a transmission spectrum by filtering electrical data to reduce adjacent symbol interference caused by dispersion in the optical channel. In one embodiment, the bandwidth of transmission spectrum is substantially optimized and may have 100% excess bandwidth.

The transmission spectrum is modulated on an optical signal. The modulated optical signal is transmitted across the optical channel. The transmitted optical signal is detected and converted into a received electrical data signal. The received electrical data signal is filtered to reduce adjacent symbol interference in the received electrical data signal. In one embodiment, the received electrical data signal is filtered to reduce adjacent symbol interference in the optical channel caused by detecting the modulated optical signal.

The method may include filtering the received electrical data signal with a filter having a transfer function that substantially maximizes the intersymbol interference limited Q. The method may also include filtering the received electrical data signal with a filter that transforms the detected electrical data signal to a signal that has an autocorrelation function that is substantially equal to that of the electrical data generated by the data source.

### BRIEF DESCRIPTION OF THE DRAWINGS

This invention is described specifically in the appended claims. The above and further advantages of this invention may be better understood by referring to the following description in conjunction with the accompanying drawings, in which like numerals indicate like structural elements and features in various figures. The drawings are not necessarily to scale, emphasis instead being placed upon illustrating the principles of the invention.

FIG. 1 illustrates an optical fiber communication system using tandem transmit and receive filters according to the present invention.

FIG. 2a illustrates a prior art transmitter filter transfer function of an optical fiber communication system.

FIG. 2b illustrates an exemplary transfer function of a transmitter filter according to the present invention for an optical fiber communication system with high residual (i.e. uncompensated) dispersion.

FIG. 3 illustrates a table of exemplary receiver filter parameters for a receiver filter according to the present invention for use in an optical fiber communication system with high residual dispersion.

FIG. 4a illustrates a simulated eye diagram for a 10 Gb/s optical fiber communication system with 1,600 ps/nm link dispersion that includes the prior art transmitter filter described in connection with FIG. 2a.

FIG. 4b illustrates the receiver filter transfer function that is included in the simulation of the optical fiber communication system with 1,600 ps/nm (which scales to 100 ps/nm for 40 Gb/s) link dispersion described in connection with FIG. 4a.

FIG. 5a illustrates a simulated eye diagram for an optical fiber communication system including the tandem transmitter and receiver filters of the present invention and having 1,600 ps/nm (100 ps/nm for 40 Gb/s) link dispersion.

FIG. 5b illustrates the receiver filter transfer function that is included in the simulation of the optical fiber communication system including the tandem transmitter and receiver filters of the present invention and having 1,600 ps/nm (100 ps/nm for 40 Gb/s) link dispersion described in connection with FIG. 5a.

### DETAILED DESCRIPTION

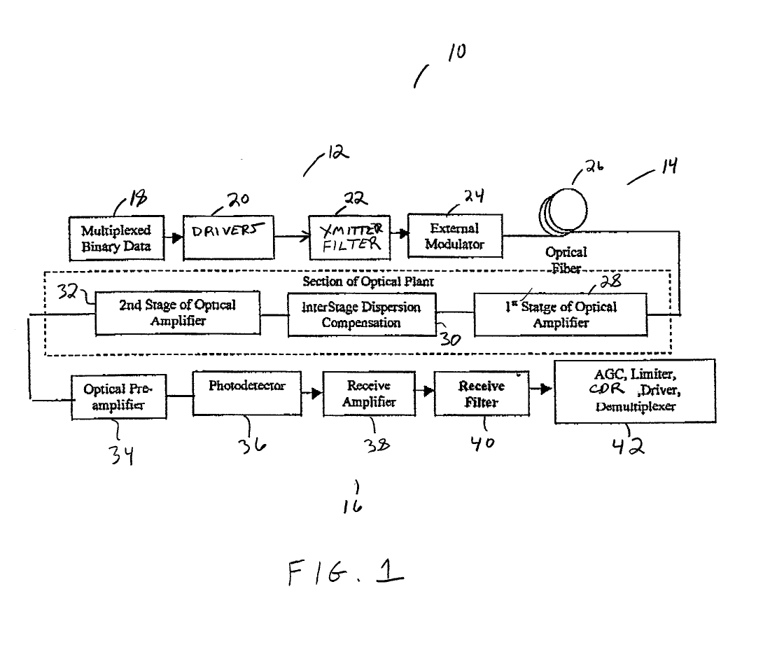

FIG. 1 illustrates an optical fiber communication system 10 using tandem transmit and receive filters according to the present invention. The system 10 generally includes a transmitter 12, an optical channel 14, and a receiver 16. The transmitter 12 includes an electrical information or data source 18 that provides digital information to be transmitted in the communication system 10. In one embodiment, the data source 18 is a multiplexed binary data source.

The transmitter 12 also includes high-speed electrical drivers 20. The drivers 20 convert the information from the data source 18 to high-speed electrical signals that represent the information. The drivers 20 generate RF signals that have signal levels adequate to drive the modulator.

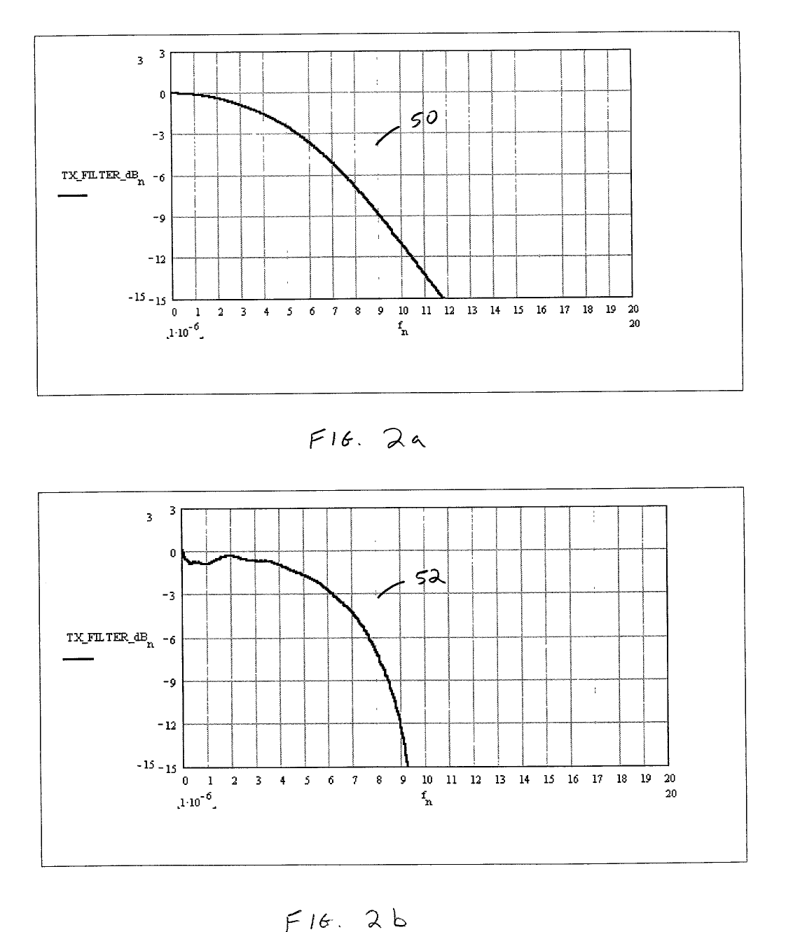

The communication system 10 also includes a transmitter filter 22 that is coupled to the output of the drivers 20. The transmitter filter 22 filters the digital information. The transmitter filter 22 is designed to reduce ISI caused by nonlinearities, such as dispersion in the optical fiber and photodetection as described herein. In one embodiment, the transmitter filter 22 has a transfer function that has substantially optimized bandwidth and roll-off characteristic that limits the adjacent symbol interference on the transmitted signal, as described in connection with FIG. 2b.

The transmitter 12 also includes an external modulator 24. The external modulator 24 can be a chirped modulator, low-chirp, or chirp-free modulator. One advantage of the communication system of the present invention is that the tandem filter design significantly extends the transmission distances and dispersion tolerance for low-chirp or chirp-free modulator. The optical modulator impresses or modulates RF electrical signals from the information source 12 onto a laser in order to generate a modulated optical signal that carries data.

External modulation can be accomplished by using an external modulator that is separate from the optical source. External modulation is advantageous because it can modulate signals over a very wide bandwidth. External modulators are typically voltage-controlled devices that include a traveling-wave electrode structure, which is positioned in close proximity to the optical waveguide. The electrode structure produces an electric field that overlaps the optical waveguide and causes an electro-optic interaction, which modulates the optical signal.

Lithium niobate (LN) electro-optic external modulators are commonly used to modulate data on optical signals that are being transmitted at very high data rates and over long distances. Lithium niobate modulators are advantageous because they can modulate optical signal over a broad frequency range, they modulate optical signals with controlled chirp and they operate efficiently over a broad wavelength range. These features are particularly desirable for DWDM communication systems.

In other embodiments, the data source 18 is modulated with a III-V based external modulator. Modulation may also be accomplished by modulating the optical intensity of light leaving the laser with an separate (EA) or integrated (EML or ILM) electro-absorption modulator.

The communication system 10 includes an optical fiber 26 that is optically coupled to the output of the external modulator 24. The optical fiber 26 propagates the modulated information along the optical channel, which may be hundreds or thousands of kilometers. The optical fiber 26 is typically a dispersive and nonlinear medium that causes pattern dependent noise or Intersymbol Interference (ISI) in the optical data.

The receiver 16 is optically coupled to an end of the optical fiber 26. The receiver 16 normally is preceded by at least one optical amplifier 28 that amplifies the optical signal. Optical amplification is needed for most applications because the modulated data is attenuated after transmission though the optical fiber 26.

In one embodiment, the receiver 16 includes a dispersion compensation unit 30 to compensate for chromatic and polarization mode dispersion induced by the optical fiber 26. Chromatic dispersion refers to a phenomenon where different frequency components of the data signal travel with different group velocities in the optical fiber and, thus arrive at the receiver 16 at different times. Chromatic dispersion is a characteristic of the fiber. Different fibers have different chromatic dispersion profiles. Chromatic dispersion accumulates with the propagation distance, so the amount of dispersion is proportional to the length of the optical channel.

A second optical amplifier 32 may be optically coupled to the dispersion compensation unit 30. The second optical amplifier 32 amplifies the dispersion compensated optical signal. An optical pre-amplifier 34 may be used to amplify the dispersion compensated optical signal so that the amplified signal level is compatible with photodetector 36.

The photodetector 36 converts the amplified optical signal into an electrical data signal. The photodetector 36 may be a high-speed photodiode with sufficient bandwidth to detect the transmitted information. The photodetector 36 detects and convert the received optical data signal into an electrical data signal. The detection and amplification conversion of the received optical data signal causes additional ISI in the detected electrical data. The tandem transmitter and receiver filters of the present invention reduce the ISI in the detected electrical data as described herein.

The receiver 16 also includes an electronic receiver amplifier 38 that amplifies the electrical data signal to useful electronic signal levels. The receiver 16 also includes a receiver filter 40. The transfer function of the receiver filter 40 is designed to reduce ISI caused by nonlinearities, such as dispersion in the optical fiber and bandlimited photodetection as described herein.

In addition, the receiver 16 includes additional electronics that process the electrically filtered signal. The receiver 16 may include automatic gain control and limiting circuits. The receiver 16 also may include clock and data recovery demultiplexing circuits that process the received data signals so that they are compatible with data and voice equipment.

There are several methods of reducing ISI in the communication system 10 of the present invention. One method is to use a chirped modulator to compensate for dispersion. However, chirped modulators are undesirable for many applications because they are relatively unstable to environmental changes and may require higher drive voltages than un-chirped external modulators.

Another method of reducing ISI in the communication system 10 is to use equalization. In this method, the transmitter 22 and the receiver's equalization filter 40 are designed to make the overall channel characteristic obey the Nyquist criterion. That is, the channel bandwidth is at least ½T of the transmitter 22 and the receiver's equalization filter 40. The Nyquist criterion is well known in the art. Careful attention to the phase response of the equalization is especially important in high-speed optical communications.

One method of equalizing a linear channel uses matched linear phase filters in the transmitter and the receiver that have a frequency response, which approximates the square root of a raised cosine function. Another method of equalizing linear channels uses maximum phase and minimum phase filters that have an asymmetrical impulses response and identical magnitude responses equal to the square root of the raised cosine characteristic.

Another method of equalizing a linear channel uses an unmatched transmitter 22 and receiver filter 40 that are chosen so that the overall linear channel characteristics obey the Nyquist criterion. That is, the transfer functions of the transmitter 22 and the receiver filter 40 are chosen so that the transmitter 12 is the “Nyquist complement” of the receiver 16 as well known in the art.

The optical channel 14 in most optical fiber communication systems is a non-linear channel because of dispersion and other non-linear effects. Dispersion and non-linear effects are significant when propagating signals having 10 Gb/s and higher data rates in an optical fiber having residual dispersion in the range of less than −800 ps/nm or greater than 1000 ps/nm (this scales to −50 ps/nm and 67 ps/nm for 40 Gb/s). Many commercial optical fiber systems have residual dispersion in this range. For example, 80-100 km of SMF-28 standard single mode fiber propagating optical signals having a wavelength of approximately 1550 nm has 1400 to 1700 ps/nm residual dispersion. Such optical fibers are widely deployed in commercial communication systems. Dispersion compensation is becoming increasingly important in optical communication systems because of a rapid trend towards increasing the number of channels in fiber optic communication systems, which decreases the channel spacing in the optical channel.

The optical fiber communication system 10 including the tandem transmitter and receiver filters according to the present invention can reduce ISI caused by nonlinearities, such as dispersion in the optical channel and dispersion explicitly caused by photodetection. In fact, the receiver 16 can be made substantially free of adjacent symbol interference (ASI) and the transmitter can be made nearly free of ASI by properly choosing the transmitter 22 and the receiver filter 40 transfer functions according to the present invention.

FIG. 2a illustrates a prior art transmitter filter transfer function of an optical fiber communication system. The transfer function 50 has a 4^{th} order Bessel Thompson filter characteristic with a −3 dB frequency of 5.7 GHz. An optical fiber communication system using such a filter has an ASI of approximately 6.7 to 7.7% when the modulator is operating at 75% of saturation and is biased at −12.5 degrees. The ASI can be quantified by autocorrelating the transmitted signal and evaluating the autocorrelation at one bit delay.

FIG. 2b illustrates an exemplary transfer function 52 of a transmitter filter according to the present invention for an optical fiber communication system with high positive dispersion. The transmitter filter has a substantially optimized bandwidth and a relatively sharp roll-off characteristic. Such a transmitter filter limits the adjacent symbol interference (ASI) on the transmitted signal to substantially less than 3%. Numerous other transmitter filters can be used in a fiber optic communication system of the present invention.

The transfer function 52 has a filter characteristic with nearly a 100% raised cosine shape. Using a transmitter filter with substantially 100% excess bandwidth at the transmitter is desirable for the tandem transmitter and receiver filter design of the present invention. Using a filter with substantially less than 100% excess bandwidth at the transmitter is undesirable because it will increase high frequency peaking of the receiver filter 40. Using a filter with substantially greater than 100% excess bandwidth at the transmitter is also undesirable because such a filter launches an unnecessarily wide bandwidth signal into a dispersive medium. The filtered signal therefore has a spectrum with maximum frequency content above the symbol rate R.

The receiver filter 40 (FIG. 1) is designed to transform the detected signal to a signal that has an autocorrelation, which is equal to the desired pulse response (DPR) for a specified range of autocorrelation time lags (one to two bit intervals). The desired pulse response (DPR) is typically the response where the overall system response is substantially free of ISI and the Q of the system is maximized. The receiver filter 40 may have a transfer function that exhibits peaking at a frequency and amplitude, which is dependent on the link dispersion. Most importantly, the receiver filter 40 has a response that is a function link dispersion.

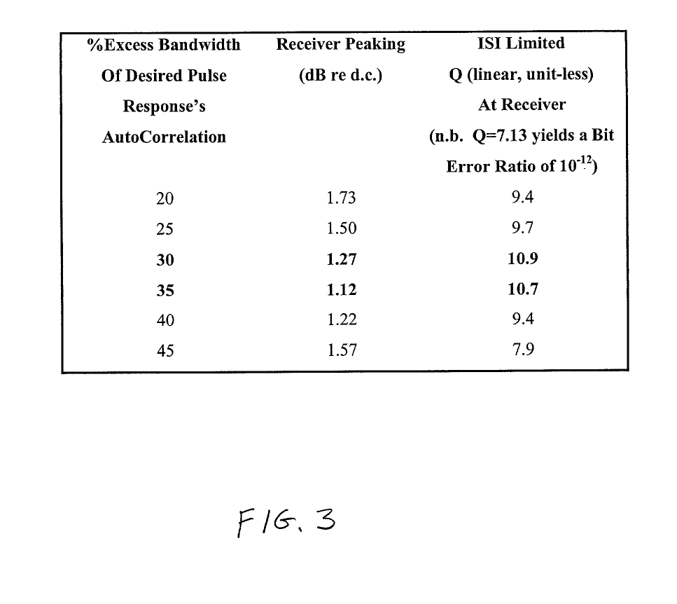

FIG. 3 illustrates a table of exemplary receiver filter parameters for a receiver filter 40 according to the present invention for use in an optical fiber communication system with high dispersion. The data in the table indicates that it is desirable to design the receiver filter 40 so that it transforms the detected signal to a signal that has an autocorrelation that is equal to a DPR of approximately 30 to 35% excess bandwidth in order to maximize the statistic Q of the system 10. Thus, the bandwidth to the first (and subsequent) null in the received filtered signal is approximately 1.325*R/2.

The resulting peak in the receiver filter 40, which equalizes the aggregated effects of dispersion, nonlinear propagation, and detection, is approximately 1.2 dB. Using more bandwidth at the transmitter decreases the amount of peaking of the receiver filter 40 response because there will be enhanced high frequency components in the detected signal. Conversely, using less bandwidth at the transmitter will increase the amount of peaking at the receiver. Note that this peaking characteristic has a different phase response than is usually achieved with inductive peaking of a photodetector-transimpedance amplifier response curve.

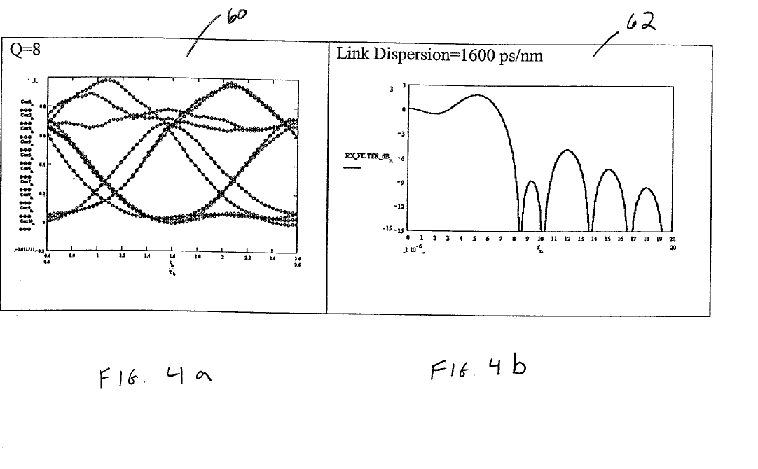

FIG. 4a illustrates a simulated eye diagram 60 for an optical fiber communication system with 1,600 ps/nm (100 ps/nm for 40 Gb/s) link dispersion that includes a prior art transmitter filter. The simulation includes a prior art 4^{th} order Bessel Thompson transmitter filter with a −3 dB frequency of 5.7 GHz, as described in connection with FIG. 2a. The simulation also includes 100 km of SMF-28 standard single mode fiber propagating optical signals having a wavelength of approximately 1550 nm.

In addition, the simulation includes a chirp-free modulator that is biased at −12.5 degrees and at 75% saturation of the RF drive signal. The launch power is simulated at 7 dBm peak and the data rate is simulated at 9.95 Gb/s. The S21 response and the sinusoidal nonlinearity of a commercial JDS Uniphase Corporation 10 Gb/s Mach-Zehnder Lithium Niobate external modulator is included in the simulation. FIG. 4a illustrates that the ISI limited Q at the receiver using the prior art transmitter filter is approximately eight.

FIG. 4b illustrates the receiver filter transfer function 62 that is included in the simulation of the optical fiber communication system with 1,600 ps/nm (100 ps/nm for 40 Gb/s) link dispersion described in connection with FIG. 4a. The receiver filter 40 is designed to maximize the ISI limited Q, as described in connection with FIG. 3. The receive filter 40 exhibits peaking at a frequency and amplitude which is dependent on the link dispersion. The receive filter 40 also exhibits a 3 dB frequency that increases with the link dispersion and, most importantly, an equalization response that reduces ASI to a minimum. The sidelobes observed on the receiver filter transfer functions can be reduced by controlling the transmitter spectrum and by using known filter design techniques.

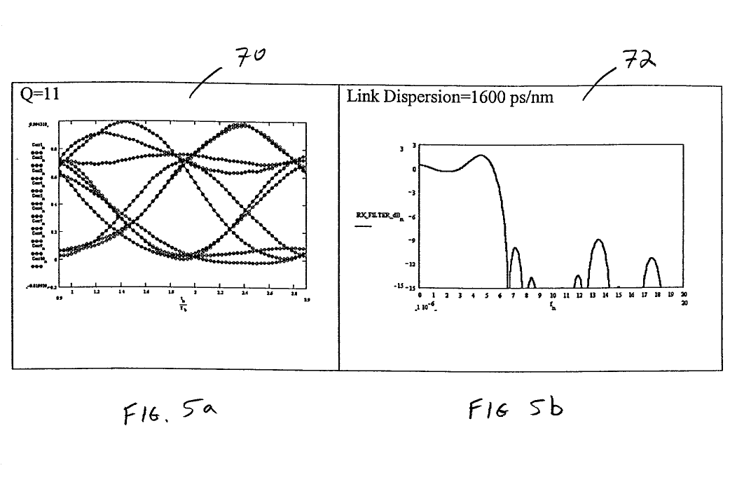

FIG. 5a illustrates a simulated eye diagram 70 for a 10 Gb/s optical fiber communication system including the tandem transmitter and receiver filters of the present invention and having 1,600 ps/nm link dispersion (100 ps/nm for 40 Gb/s). The simulation used a transmitter filter transfer function 72 that has a substantially optimized bandwidth and a rolloff characteristic that, in combination with the receiver's equalization filter, results in a relatively low ASI. The transfer function 72 is a 4^{th} order Bessel Thompson filter characteristic with a −3 dB frequency of 5.7 GHz and substantially 100% excess bandwidth as described in connection with FIG. 2b.

In addition, the simulation includes 100 km of SMF-28 standard single mode fiber propagating optical signals having a wavelength of approximately 1550 nm. The simulation also includes a chirp-free modulator that is biased at −12.5 degrees and at 75% saturation of the RF drive signal. The launch power is simulated at 7 dBm peak and the data rate is simulated at 9.95 Gb/s. The S21 response and the sinusoidal nonlinearity of a commercial JDS Uniphase Corporation 10 Gb/s Mach-Zehnder interferometric modulator is included in the simulation. FIG. 5a illustrates that the ISI limited Q at the receiver using the transmitter filter with substantially optimized bandwidth and roll-off is approximately eleven.

FIG. 5b illustrates the receiver filter transfer function 72 that is included in the simulation of the optical fiber communication system including the tandem transmitter and receiver filters of the present invention and having 1,600 ps/nm link dispersion for 10 Gb/s (or 100 ps/nm for 40 Gb/s) described in connection with FIG. 5a. The receiver filter 40 is designed to maximize the ISI limited Q, as described in connection with FIG. 3. The receive filter 40 exhibits peaking at a frequency and amplitude which is dependent on the link dispersion. The receive filter 40 also exhibits a −3 dB cut-off frequency that increases with the link dispersion and a phase response that equalizes the channel, producing a low ASI and ISI-limited Q. The sidelobes observed on the receiver filter transfer functions can be reduced by controlling the transmitter spectrum's excess bandwidth and by using known filter design techniques.

Thus, an optical fiber communication system that includes the tandem transmitter and receiver filter of the present invention has a substantially higher Q for highly dispersive optical channels compared with prior art optical fiber communication systems. The tandem transmitter and receiver filter design of the present invention significantly reduces the dispersion penalty at 10 Gb/s and above for channels with high dispersion.

### EQUIVALENTS

While the invention has been particularly shown and described with reference to specific preferred embodiments, it should be understood by those skilled in the art that various changes in form and detail may be made therein without departing from the spirit and scope of the invention as defined by the appended claims. For example, the present invention can be used with zero-chirp or chirped modulators.

What is claimed is:

1. An optical communication system comprising:
a. a data source for generating electrical data;
b. a transmission filter having a transfer function that reduces adjacent symbol interference in a transmission spectrum, the transmission filter filtering the electrical data generated by the data source and passing the transmission spectrum;
c. a modulator for modulating the transmission spectrum on an optical signal;
d. a detector for detecting the modulated optical signal transmitted across an optical channel and converts the detected modulated optical signal to a received electrical data signal; and
e. a receiver filter having a transfer function that reduces adjacent symbol interference in the received electrical data signal, the receiver filter equalizing the phase and amplitude of the received electrical data signal in order to obey the Nyquist criterion.

2. The communication system of claim 1 wherein the optical channel is a dispersive optical channel.

3. The communication system of claim 2 wherein the transfer function of the receiver filter is dependent upon the dispersion across the optical channel.

4. The communication system of claim 3 wherein the transfer function of the receiver filter has a peak transmission and a phase equalization response that is a function of the dispersion across the optical channel.

5. The communication system of claim 1 wherein the transfer function of the transmitter filter has substantially optimized bandwidth.

6. The communication system of claim 1 wherein the transfer function of the transmitter filter has substantially 100% excess bandwidth.

7. The communication system of claim 1 wherein the transfer function of the receiver filter reduces adjacent symbol interference in the received electrical data signal resulting from dispersion in the optical channel.

8. The communication system of claim 1 wherein the transfer function of the receiver filter reduces adjacent symbol interference in the received electrical data signal resulting from at least one of non-linear propagation and photodetection.

9. The communication system of claim 8 wherein an equalization of the transfer function of the receiver filter reduces adjacent symbol interference in the received electrical data signal resulting from at least one of non-linear propagation and photodetection.

10. The communication system of claim 1 wherein the transfer function of the receiver filter substantially maximizes the intersymbol interference limited Q.

11. The communication system of claim 1 wherein the modulator comprises a substantially chirp-free modulator.

12. The communication system of claim 1 wherein the receiver filter transforms the detected electrical data signal to a signal that has an autocorrelation function that is substantially equal to a portion of the electrical data generated by the data source.

13. The communication system of claim 11 wherein the autocorrelation function has an adjacent symbol interference that is less than 5%.

14. An optical communication system comprising:
a. a data source for generating electrical data;
b. a transmission filter having a transfer function that has substantially optimized bandwidth, the transmission filter filtering the electrical data generated by the data source and passing the transmission spectrum;
c. a modulator for modulating the transmission spectrum on an optical signal;
d. a detector for detecting the modulated optical signal transmitted across a dispersive optical channel and converts the detected modulated optical signal to a received electrical data signal; and
e. a receiver filter having a transfer function that reduces adjacent symbol interference in the received electrical data signal resulting from dispersion in the optical channel, the receiver filter filtering the received electrical data signal.

15. The communication system of claim 14 wherein the modulator comprises a substantially chirp-free modulator.

16. The communication system of claim 14 wherein the transfer function of the transmitter has substantially 100% excess bandwidth.

17. The communication system of claim 14 wherein the transfer function of the receiver filter substantially maximizes the intersymbol interference limited Q.

18. The communication system of claim 14 wherein the transfer function of the receiver filter has a peak transmission that is a function of the dispersion across the optical channel.

19. The communication system of claim 14 wherein the transfer function of the receiver filter reduces adjacent symbol interference in the received electrical data signal resulting from non-linear effects of propagation and photodetection.

20. The communication system of claim 14 wherein the receiver filter transforms the detected electrical data signal to a signal that has an autocorrelation function that is substantially equal to a portion of the electrical data generated by the data source.

21. The communication system of claim 20 wherein the autocorrelation function has an adjacent symbol interference that is less than 5%.

22. A method of reducing intersymbol interference in an optical channel, the method comprising:
a. generating a transmission spectrum by filtering electrical data to reduce adjacent symbol interference caused by dispersion in the optical channel;
b. modulating the transmission spectrum on an optical signal;
c. transmitting the modulated optical signal across the optical channel;
d. detecting the modulated optical signal transmitted across the optical channel and converting the detected modulated optical signal into a received electrical data signal; and
e. filtering the received electrical data signal to reduce adjacent symbol interference.

23. The method of claim 22 further comprising filtering the received electrical data signal to reduce adjacent symbol interference in the optical channel caused by detecting the modulated optical signal.

24. The method of claim 22 further comprising optimizing the bandwidth of transmission spectrum.

25. The method of claim 21 wherein the peak transmission of the transmission spectra is a function of the dispersion in the optical channel.

26. The method of claim 22 further comprising filtering the received electrical data signal to substantially maximize the intersymbol interference limited Q.

27. The method of claim 22 further comprising filtering the received electrical data signal to transform the detected electrical data signal to a signal that has an autocorrelation function that is substantially equal to a portion of the electrical data generated by the data source.
